(19) United States
(12) Patent Application Publication
(10) Pub. No.: US 2006/0282249 A1
(43) Pub. Date: Dec. 14, 2006

(54) Circuit simulation method and circuit simulation apparatus

(75) Inventors: Daisaku Ikoma, Osaka (JP); Kyoji Yamashita, Kyoto (JP); Katsuhiro Ootani, Nara (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/349,077

(22) Filed: Feb. 8, 2006

(30) Foreign Application Priority Data
Jun. 9, 2005 (JP) 2005-169199

(51) Int. Cl. G06F 17/50

(52) U.S. Cl. 703/13

(57) ABSTRACT

In designing a semiconductor integrated circuit, circuit information used for circuit simulation is extracted from measurement values of electric characteristics of a device included in TEG and parameters included in a netlist are modified using the measurement values and simulation values. Circuit simulation is carried out using the thus modified netlist to lead to a decrease in error in the circuit simulation which is caused due to difference between design dimension and actual finished dimension, thereby preventing an increase in design margin and a yield lowering by malfunction.

### CROSS REFERENCE TO RELATED APPLICATIONS

This Non-provisional application claims priority under 35 U.S.C. § 119(a) on Patent Application No. 2005-169199 filed in Japan on Jun. 9, 2005, the entire contents of which are hereby incorporated by reference.

### BACKGROUND OF THE INVENTION

1. Field of the Invention

The present invention relates to a circuit simulation method and a circuit simulation apparatus in which circuit information used for designing a semiconductor integrated circuit is extracted from electric characteristics of a real device and the extracted circuit information is used.

2. Description of the Prior Art

Recently, in association with progress in process technology and design technology, performance and integration of semiconductor integrated circuits (LSIs) increase remarkably. In association with progress in device miniaturization, gate length and gate width of transistors included in LSIs are shortened further and further, inviting an increase in variation in gate length and gate width and an increase in difference between design dimension and actual measurement dimension of a device. This increases a variation in propagation delay time of circuits and difference between actual measurement result and simulation result to invite an increase in design margin. As a result, difficulties are encountered in providing high performance LSIs.

A currently-performed general circuit simulation is carried out as follows.

FIG. 6 is a flowchart showing a general circuit simulation method. In the first step, a netlister 1102 receives design layout information 1101 as an input and generates a netlist 1103 on the basis of connection information of an active element (a transistor or the like), a parasitic element (a wiring resistor or the like), and the like and element dimension information which are included in the design layout information 1101. Next, in the second step, the circuit simulator 1104 performs circuit simulation with the use of the netlist 1103 as an input from the netlister 1102 and outputs circuit characteristic information 1105 such as delay time, leakage current, and the like.

Referring to a general semiconductor manufacturing process, an integrated circuit is formed on a semiconductor substrate by repetition of a photolithography step including resist application, exposure, and development, an etching step for pattering elements with the use of a resist mask, and a resist removing step.

FIG. 7 shows a design layout pattern and an actually-obtained finished pattern of gates 1111 and active regions 1112 in a semiconductor integrated circuit. For forming the gates 1111 and the active regions 1112 of a transistor as shown in FIG. 7, the photolithography step, the etching step, and the resist removing step are carried out, likewise. When the pattern dimension is less than the wavelength of the exposure light at exposure in the photolithography step, difference between the layout dimension at design and the actual dimension of the pattern on the semiconductor substrate becomes large due to the optical proximity effect by influence of diffracted light and coherent light.

For tackling the above disadvantages, there are developed various techniques such as super resolution using a phase shift mask, OPC (Optical Proximity Correction) for correcting influence of the optical proximity effect by modifying a circuit pattern drawn on a mask, and the like. However, the optical proximity effect is inevitable in principal, and accordingly, it is difficult to eliminate it only by manufacture and process techniques such as the super resolution, the OPC, and the like. Under the circumstances, various approaches in the design stage have been developed, such as a semiconductor device layout design impervious to the influence of the optical proximity effect, prediction of finished dimension with the use of litho-simulation, and the like (see Japanese Patent Application Laid Open Publication No. 2002-203907A, for example). An increase in accuracy in circuit simulation has been tried through these approaches.

Further, the gate length and the gate width are shortened in association with progress in miniaturization of transistors, as described above, so that the influence of the optical proximity effect by diffracted light at exposure of the gates and the active regions becomes severe. The optical proximity effect in gate formation occurs depending on a layout pattern of the gates and the active regions of a transistor. In other words, an error (difference between design dimension and actually-measured finished dimension) in gate length and gate width which depends on layout occurs. An increase in error in gate length and gate width increases variations in driving capability, capacity characteristic, and the like of transistors to directly provide influence on circuit performance, increasing error in circuit simulation. This invites an increase in design margin and malfunction.

In order to alleviate the above disadvantages, there are actively promoted an approach in which a finished shape is measured using SEM (Scanning Electron Microscope) and the measurement result is reflected in circuit simulation, technical developments in the OPC, and the like. Techniques for predicting a finished shape with the use of the aforementioned litho-simulation have been developed besides, which cannot offer any absolute solution yet. Also, the SEM requires longer time for measurement than electric characteristic measurement, and accordingly, it is difficult in practice to measure all transistors having different layout patterns to be used for an LSI. In the OPC, since patterns having part smaller than the wavelength of exposure light are exposed, the influence of the optical proximity effect cannot be eliminated thoroughly. Therefore, the difference between design dimension and finished dimension cannot be ignored even with the use of the forefront OPC technique. In the recent litho-simulation technique, the litho-simulation itself involves large error, resulting in reflection of poor information of finished dimension to the circuit simulation.

### SUMMARY OF THE INVENTION

The present invention has been made in view of the above problems and has its object of increasing accuracy in circuit simulation by taking account of differnce between design dimension and actual finished dimension in designing a semiconductor integrated circuit.

A circuit simulation method of the present invention is a circuit simulation method using design layout information including a plurality of parameters of a transistor having a gate, including: a step (a) of extracting a netlist including the plurality of parameters from the design layout information; a step (b) of obtaining measurement values by measuring a first electric characteristic and a second electric characteristic of the transistor; a step (c) of obtaining simulation values of the first electric characteristic and the second electric characteristic of the transistor which are expressed as functions of the plurality of parameters by carrying out simulation; a step (d) of calculating modified values of the plurality of parameters with the use of a first relational expression of the plurality of parameters where the measurement value of the first electric characteristic agrees with the simulation value of the first electric characteristic and a second relational expression of the plurality of parameters where the measurement value of the second electric characteristic agrees with the simulation value of the second electric characteristic; a step (e) of modifying the netlist with the use of the modified values of the plurality of parameters; and a step (f) of carrying out circuit simulation with the use of the netlist modified in the step (e).

In the above method, the netlist modified on the basis of the actual measurement values of the electric characteristics is used to enable the circuit simulation in which difference between design dimension and actual finished dimension and the like are corrected, increasing accuracy in the circuit simulation. As a result, disadvantages such as an increase in design margin, malfunction, and the like can be suppressed even when an integrated circuit is further miniaturized.

In the circuit simulation method of the present invention, the netlist is modified with the use of N kinds of parameters and N kinds of electric characteristics of a transistor (wherein N is an integer larger than 1). The parameters include gate length and gate width of a transistor, carrier mobility in the transistor, threshold voltage of a device having a long channel, and the like. The electric characteristics to be measured include drain current, output conductance, threshold voltage, transconductance, and the like of the transistor. Herein, the transistor is a MISFET, for example.

The circuit simulation method of the present invention is performed by a computer which stores a circuit simulator or a device simulator, an exclusive circuit simulation apparatus provided with parameter extracting means, or the like.

### BRIEF DESCRIPTION OF THE DRAWINGS

FIG. 1 is a flowchart showing a circuit simulation method according to embodiments of the present invention.

FIG. 2A and FIG. 2B are graphs indicating gate length Lg and gate width W in the condition where an actual measurement value of drain current Ids is equal to a simulation value thereof and in the condition where an actual measurement value of output conductance Gds is equal to a simulation value thereof, respectively, in a circuit simulation method according to Embodiment 1 of the present invention.

FIG. 3 is a graph for explaining a method for obtaining effective gate length Lg effective and gate width W from characteristic curves in FIG. 2A and FIG. 2B in the circuit simulation method according to Embodiment 1.

FIG. 4 is a graph indicating gate length Lg and gate width W in the condition where an actual measurement value of the drain current Ids is equal to the simulation value thereof and in the condition where an actual measurement value of threshold voltage Vth is equal to a simulation value thereof in a circuit simulation method according to Embodiment 2 of the present invention.

FIG. 5A and FIG. 5B are graphs for explaining a method for obtaining three kinds of effective parameters with the use of actual measurement values and simulation values of three kinds of electric characteristics in a circuit simulation method according to Embodiment 3 of the present invention.

FIG. 6 is a flowchart showing a general circuit simulation method.

FIG. 7 is a drawing showing a design layout pattern and an actually-obtained finished pattern of gates and active regions in a semiconductor integrated circuit.

### DESCRIPTION OF THE PREFERRED EMBODIMENTS

### Embodiment 1

Embodiment 1 of the present invention will be described below with reference to the accompanying drawings.

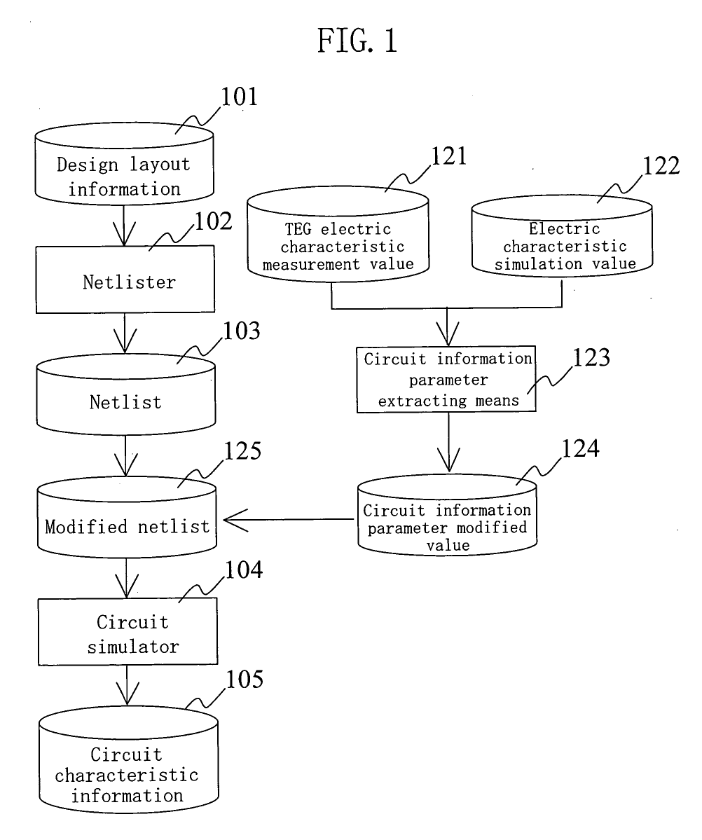

FIG. 1 is a flowchart showing a circuit simulation method according to the embodiments of the present invention. As shown in FIG. 1, in the circuit simulation method according to the present invention, a netlist 103 is generated from design layout information 101 by a netlister 102. The netlister 103 includes circuit information parameters such as gate length Lg, gate width W, and the like.

Meanwhile, electric characteristics of a device included in TEG (Test Elementary Group) are measured to obtain TEG electric characteristic measurement values 121. Also, simulation for the electric characteristics of the device is performed to obtain electric characteristic simulation values 122. It is preferable to store the TEG electric characteristic measurement values 121 and the electric characteristic simulation values 122 in a storage device such as a memory, for example.

Next, circuit parameter extracting means (parameter extraction section) 123 extracts circuit information parameter modification values 124 on the basis of the condition where the TEG electric characteristic measurement values 121 agree with the simulation result of the electric characteristics (the electric characteristic simulation values 122).

Subsequently, the netlist 103 is modified using the circuit information parameter modification values 124 to generate a modified netlist 125.

Then, circuit simulation is performed using the modified netlist 125 as an input by a circuit simulator 104 such as SPICE and circuit characteristic information 105 is output which includes information on delay time, leakage current, and the like.

In the circuit simulation method of the present embodiment, drain current Ids and output conductance Gds of a MIS transistor are used as the TEG electric characteristic measurement values 121 while gate length Lg and gate width W are used as the circuit information parameters. The drain current Ids and the output conductance Gds are items to be measured usually in electric measurement of a device included in TEG. Wherein, the output conductance Gds is obtained by differentiating the drain current Ids by source-drain voltage Vds. The gate length Lg and the gate width W affect the driving capability of a MIS transistor dominantly, so that difference in gate length Lg and gate width W between design dimension and finished dimension influences the circuit characteristics severely. Accordingly, if the gate length Lg and the gate width W would be modified according to the actually-measured electric characteristics of an actual device, significant effects would be exhibited at reduction in error in circuit simulation. From this viewpoint, the gate length Lg and the gate width W are selected as the circuit information parameters in the present embodiment.

A method for extracting effective gate length Lg and effective gate width W in Embodiment 1 will be described next. In the present description, “the effective gate length Lg and the effective gate width W” mean gate length and gate width which are modified so as to be suited to characteristics of an actually-manufactured device.

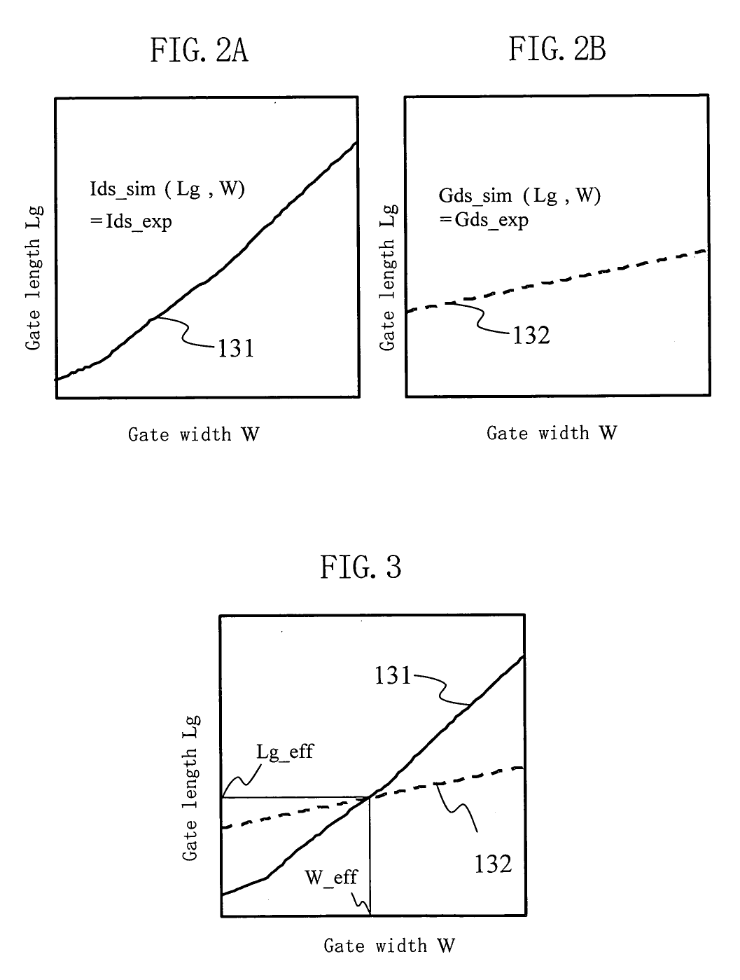

FIG. 2A and FIG. 2B are graphs indicating gate length Lg and gate width W in the condition where an actual measurement value of drain current Ids is equal to a simulation value thereof and in the condition where an actual measurement value of output conductance Gds is equal to a simulation value thereof, respectively, in the circuit simulation method according to the present embodiment. Also, FIG. 3 is a graph for explaining a method for obtaining the effective gate length Lg and the effective gate width W from characteristic curves in FIG. 2A and FIG. 2B in the circuit simulation method according to the present embodiment.

First, the drain current Ids and the output conductance Gds are extracted as functions of the gate length Lg and the gate width W by a circuit simulator such as SPICE or a device simulator. Herein, the drain current Ids and the output conductance Gds obtained at this point are denoted as Ids_sim (Lg, W) and Gds_sim (Lg, W), respectively. In the SPICE simulation, preferably, parameters suited to characteristics of a wafer from which the gate length Lg and the gate width W are extracted are used as SPICE model parameters because differences between the effective gate length Lg and finished gate length Lg and between the effective gate width W and finished gate width W can be made small. In the simulation, a model is preferably calibrated so as to be suited to the characteristic of the wafer from which the gate length Lg and the gate width W are extracted.

The drain current Ids and the output conductance Gds of the MISFET included in TEG and subjected to the simulation are measured. The drain current Ids and the output conductance Gds measured at this point are denoted as Ids_exp and Gds_exp, respectively. Then, the gate length Lg and the gate width W are obtained which satisfy the condition where Ids_sim and Ids_exp are equal to each other, namely, Ids_exp−Ids_sim (Lg, W)=0. The curve 131 shown in FIG. 2A indicates the gate length Lg and the gate width W that satisfy this condition.

Also, as shown in FIG. 2B, the curve 132 is obtained which indicates the gate length Lg and the gate width W that satisfy the condition where Gds_exp−Gds_sim (Lg, W)=0. The output conductance Gds is a parameter that expresses the degree of device characteristic dependency on channel length in a salutation region of a MISFET and it is known that the output conductance Gds is smaller than the drain current Ids in dependency on the gate width W. Accordingly, the curve 131 and curve 132, which are different from each other in gate length Lg/gate width W dependency in the saturation region of the MISFET, each have only one solution Lg_eff, W_eff, respectively, at an intersection point on a Lg-W plane ideally. Lg_eff and W_eff at the intersection point express the effective gate length Lg and the effective gate width W that satisfy both the conditions of the drain current Ids and the output conductance Gds in an actual device.

In the case where the curve 131 does not intersect with the curve 132, the point where distance between the curve 131 and the curve 132 is a minimum except that the gate length Lg and the gate width W are 0 is used to indicate the effective gate length Lg and the effective gate width W. Alternatively, the effective gate length Lg and the effective gate width W may be extracted at a point where αx²+βy² is a minimum with arbitrary weight constants α and β set and added to importance of a drain current characteristic and an output conductance characteristic, respectively. Wherein, x denotes a distance from the curve 131 and y denotes a distance from the curve 132.

The effective gate length Lg and the effective gate width W obtained as above are stored in a reference table or the like as the circuit information parameter modification values 124 (see FIG. 1). For circuit simulation, a MISFET described in the netlist 103 is identified, the circuit information parameters are read according to the shape and the characteristics of the MISFET while referencing the reference table to modify the netlist 103. The circuit simulation using the thus modified netlist 125 prevents degradation in accuracy in the circuit simulation which is due to difference between design dimension and finished dimension caused by the optical proximity effect. In detail, according to the present embodiment, the use of the netlist modified using two or more characteristics of a transistor, such as the drain current Ids, the output conductance Gds, and the like minimizes error in the circuit simulation which is caused due to difference between design dimension and finished dimension. Hence, prediction accuracy in the circuit simulation is increased, preventing an increase in design margin and malfunction of the circuit.

An applicable range of the MISFET from which the effective gate length Lg and the effective gate width W are extracted is not limited, namely, any MISFETs are applicable to the present embodiment. For example, in an LSI designed on cell basis, gate length Lg and gate width W respectively obtained by averaging gate lengths Lg and gate widths W of transistors in each standard cell can be used as the circuit information parameters on a standard cell level. Of course, it is possible to use four parameters of Lg_n and W_n of an N-channel transistor and Lg_p and W_p of a P-channel transistor in each standard cell as the circuit information parameters. Further, it is also possible that the layout features of a MISFET are categorized and gate length Lg and gate width W are extracted from each category.

The drain current Ids and the output conductance Gds are used as the electric characteristics of a transistor in the present embodiment. However, the electric characteristics are not limited thereto and any parameters that express characteristics of a transistor may be used for netlist modification.

It is noted that the circuit simulation method of the present embodiment may be performed by a computer and the like to which a device simulator, a circuit simulator, or the like is incorporated or by a circuit simulation apparatus provided with a circuit information parameter extraction section (circuit information parameter extracting means 124 in FIG. 1) for extracting the circuit information parameters from the measurement values and the simulation values.

### Embodiment 2

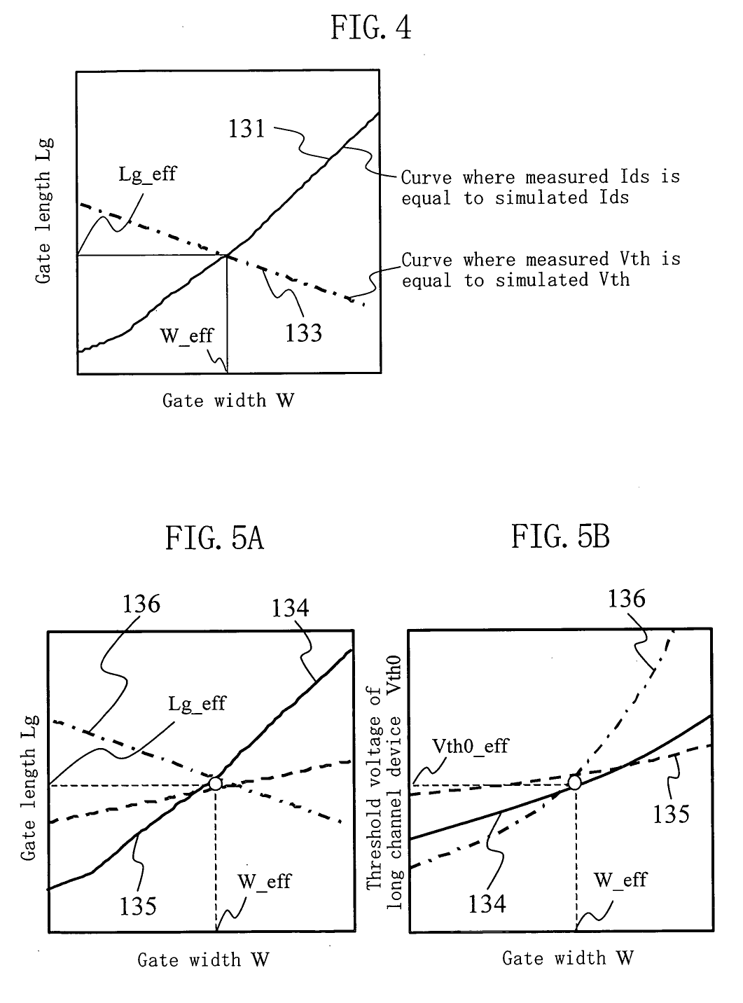

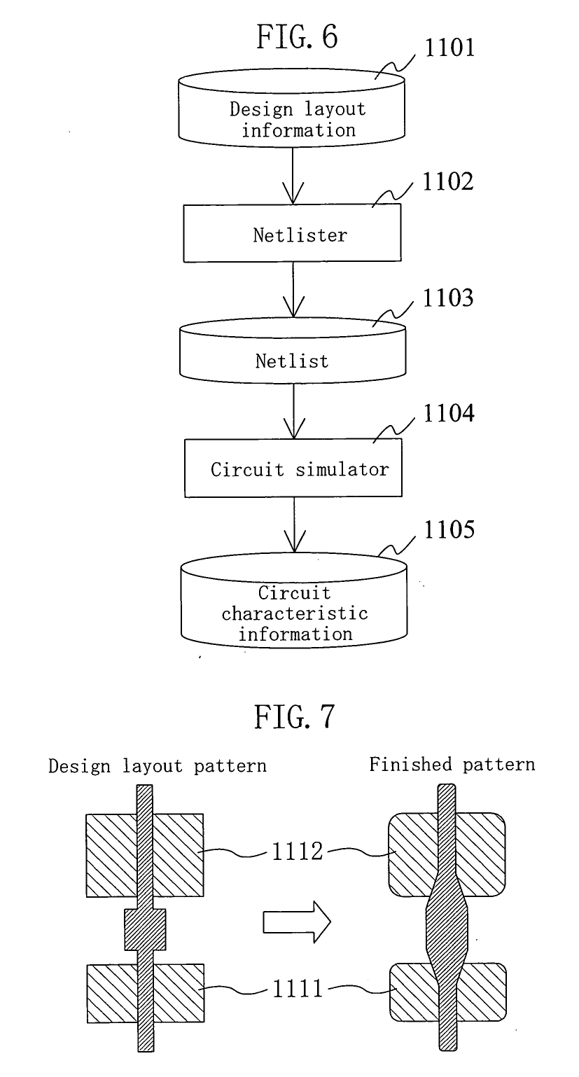

FIG. 4 is a graph indicating gate length Lg and gate width W in the condition where the actual measurement value of the drain current Ids is equal to the simulation value thereof and in the condition where an actual measurement value of threshold voltage Vth is equal to a simulation value thereof in a circuit simulation method according to Embodiment 2 of the present invention.

In the circuit simulation method according to Embodiment 2 of the present invention, the drain current Ids and threshold voltage Vth of a MISFET are used as the electric characteristic measurement values of a device included in TEG while the gate length Lg and the gate width W are used as the circuit information parameters. The drain current Ids and the threshold voltage Vth are items to be measured usually in electric measurement of a device included in TEG.

A method for extracting the effective gate length Lg and the effective gate width W in Embodiment 2 will be described below.

First, the drain current Ids and the threshold voltage Vth are calculated as functions of the gate length Lg and the gate width W by a circuit simulator such as SPICE or a device simulator. Herein, the drain current Ids and the threshold voltage Vth obtained at this point are denoted as Ids_sim (Lg, W) and Vth_sim (Lg, W), respectively.

Meanwhile, the drain current Ids and the threshold voltage Vth of the MISFET included in TEG and subjected to the simulation are measured. The drain current Ids and the threshold voltage Vth measured at this point are denoted as Ids_exp and Vth_exp, respectively. Then, the gate length Lg and the gate width W that satisfy the condition where Ids_sim and Ids_exp are equal to each other, namely, Ids_exp−Ids_sim (Lg, W)=0 are obtained. The curve 131 shown in FIG. 4 indicates the gate length Lg and the gate width W that satisfy this condition.

Also, the gate length Lg and the gate width W are obtained which satisfy the condition where Vth_exp−Vth_sim (Lg, W)=0. The curve 133 in FIG. 4 indicates the gate length Lg and the gate width W that satisfy this condition. The curve 131 and curve 133, which are different from each other in gate length Lg/gate width W dependency, each have only one solution Lg_eff, W_eff, respectively, at an intersection point on a Lg-W plane ideally, as shown in FIG. 4. Lg_eff and W_eff at the intersection point represent the effective gate length Lg and the effective gate width W.

In the case where the curve 131 does not intersect with the curve 133, the point where distance between the curve 131 and the curve 133 is a minimum except that the gate length Lg and the gate width W are 0 is used to indicate the effective gate length Lg and the effective gate width W. Alternatively, the effective gate length Lg and the effective gate width W may be extracted at the point where αx²+γz² is a minimum with arbitrary weight constants α and γ set and added to importance of the drain current characteristic and a threshold voltage characteristic, respectively. Wherein, x denotes a distance from the curve 131 and z denotes a distance from the curve 133.

The effective gate length Lg and the effective gate width W obtained as above are stored in a reference table or the like as the circuit information parameter modification values 124 (see FIG. 1). For circuit simulation, a MISFET described in the netlist 103 is identified, the circuit information parameters are read according to the shape and the characteristics of the MISFET while referencing the reference table to modify the netlist 103. The circuit simulation using the thus modified netlist 125 prevents degradation in accuracy in the circuit simulation which is due to difference between design dimension and finished dimension caused by the optical proximity effect.

The drain current Ids and the threshold voltage Vth are used as the electric characteristics of a MISFET in the circuit simulation method of the present embodiment. However, N electric characteristics selected from the drain current, the threshold voltage Vth, the output conductance Gds, and transconductance Gm may be used. In this case, N parameters selected from the gate length Lg and the gate width W of a MISFET, threshold voltage Vth0 of a device having a long channel, carrier mobility μ in the MIFSET may be used as the parameters, wherein N herein is 2.

### Embodiment 3

FIG. 5A and FIG. 5B are graphs for explaining a method for obtaining three kinds of effective parameters with the use of actual measurement values and simulation values of three kinds of electric characteristics in a circuit simulation method according to Embodiment 3 of the present invention.

In Embodiment 3 of the present invention, the drain current Ids, the output conductance Gds, and the threshold voltage Vth of a MISFET are used as the TEG electric characteristic measurement value while the gate length Lg, the gate width W, and threshold value Vth0 of a device having a long channel are used as the circuit information parameters.

A method for extracting the effective gate length Lg, the effective gate width W, and the effective threshold voltage Vth0 in Embodiment 3 will be described below.

First, the drain current Ids, the output conductance Gds, and the threshold voltage Vth of a MISFET from which the gate length Lg, the gate width W, and the threshold voltage Vth0 are to be extracted are calculated as functions of the gate length Lg, the gate width W, and the threshold voltage Vth0 by a circuit simulator such as SPICE or a device simulator. The drain current Ids, the output conductance Gds, and the threshold voltage Vth obtained at this point are denoted as Ids_sim (Lg, W, Vth0), Gds_sim (Lg, W, Vth0), and Vth_sim (Lg, W, Vth0), respectively.

Meanwhile, the drain current Ids, the output conductance Gds, and the threshold voltage Vth of the MISFET included in TEG and subjected to the simulation are measured. The drain current Ids, the output conductance Gds, and the threshold voltage Vth obtained at this point are denoted as Ids_exp, Gds_exp, and Vth_exp, respectively. As shown in FIG. 5A and FIG. 5B, a curve 134 where Ids_exp−Ids_sim (Lg, W, Vth0)=0 within Lg-W-Vth0 space is obtained using Ids_sim and Ids_exp.

A curve 135 where Gds_exp−Gds_sim (LG, W, Vth0)=0 and a curve 136 where Vth_exp−Vth_sim (Lg, W, Vth0)=0 are obtained likewise.

Because the curve 134, the curve 135, and the curve 136 scarcely intersect at one point with one another, the point where a sum of the respective distances from the curve 134, the curve 135, and the curve 136 is a minimum is obtained as the effective gate length Lg, the effective gate width W, and the effective threshold voltage Vth0. Alternatively, the effective gate length Lg, the effective gate width W, and the effective threshold voltage Vth0 of the device having a long channel may be extracted at the point where αx²+βy²+γz² is a minimum with arbitrary weight constants α, β, and γ set and added to importance of the drain current characteristic, the output conductance characteristic, and the threshold voltage characteristic, respectively.

As described above, the netlist is modified using the three kinds of electric characteristics of the transistor and the circuit simulation is carried out using the thus modified netlist, so that accuracy in the circuit simulation can be increased. Hence, disadvantages such as an increase in design margin, malfunction of the circuit, and the like can be prevented further reliably through the circuit simulation method of the present embodiment.

It is noted that the three kinds of parameters are used in the present embodiment but four or more kinds of parameters may be used. Also, four or more kinds of electric characteristics of a transistor may be used. Even with the use of four or more kinds of parameters, one point on N-dimensional space where difference between a measurement value and a simulation value is a minimum (wherein, N is an integer larger than 3) can be calculated.

Furthermore, the number of kinds of electric characteristics to be measured may be larger than the number of kinds of parameters.

The present invention is utilized for increasing accuracy in circuit simulation in designing a semiconductor integrated circuit to be incorporated in various kinds of electronic appliances.

What is claimed is:

1. A circuit simulation method using design layout information including a plurality of parameters of a transistor having a gate, comprising:
a step (a) of extracting a netlist including the plurality of parameters from the design layout information;
a step (b) of obtaining measurement values by measuring a first electric characteristic and a second electric characteristic of the transistor;
a step (c) of obtaining simulation values of the first electric characteristic and the second electric characteristic of the transistor which are expressed as functions of the plurality of parameters by carrying out simulation;
a step (d) of calculating modified values of the plurality of parameters with the use of a first relational expression of the plurality of parameters where the measurement value of the first electric characteristic agrees with the simulation value of the first electric characteristic and a second relational expression of the plurality of parameters where the measurement value of the second electric characteristic agrees with the simulation value of the second electric characteristic;
a step (e) of modifying the netlist with the use of the modified values of the plurality of parameters; and
a step (f) of carrying out circuit simulation with the use of the netlist modified in the step (e).

2. The circuit simulation method of claim 1,
wherein the number of the plurality of parameters is 2, and
in the step (d), the modified values of the plurality of parameters are obtained by obtaining an intersection point of a line expressed by the first relational expression and a line expressed by the second relational expression on a plane with the two parameters as axes.

3. The circuit simulation method of claim 2,
wherein the plurality of parameters are two parameters selected from gate length and gate width of the transistor, carrier mobility in the transistor, and threshold voltage of a device having a long channel, and
the first electric characteristic and the second electric characteristic are two electric characteristics selected from drain current, output conductance, threshold voltage, and transconductance of the transistor.

4. The circuit simulation method of claim 3,
wherein the plurality of parameters are the gate length and the gate width of the transistor, and
the first electric characteristic and the second electric characteristic are the drain current and the output conductance of the transistor, respectively.

5. The circuit simulation method of claim 3,
wherein the plurality of parameters are the gate length and the gate width of the transistor, and
the first electric characteristic and the second electric characteristic are the drain current and the threshold voltage of the transistor, respectively.

6. The circuit simulation method of claim 1,
wherein the number of the plurality of parameters is 3,
in the step (b), a third electric characteristic of the transistor is measured in addition,
in the simulation carried out in the step (c), a simulation value of the third electric characteristic of the transistor which is expressed as a function of the plurality of parameters is obtained in addition, and
in the step (d), the modified values of the plurality of parameters are obtained in such a manner that a third relational expression of the plurality of parameters where the measurement value of the third electric characteristic agrees with the simulation value of the third electric characteristic is calculated and a point where a sum of a distance from a plane expressed by the first relational expression, a distance from a plane expressed by the second relational expression, and a distance from a plane expressed by the third relational expression is a minimum in space with the three parameters as axes is obtained.

7. The circuit simulation method of claim 6,
wherein the plurality of parameters are three parameters selected from gate length and gate width of the transistor, carrier mobility in the transistor, and threshold voltage of a device having a long channel, and
the first electric characteristic, the second electric characteristic, and the third electric characteristic are three electric characteristics selected from drain current, output conductance, threshold voltage, and transconductance of the transistor.

8. A circuit simulation apparatus for performing circuit simulation with the use of design layout information including a plurality of parameters of a transistor having a gate, comprising:
a memory for storing measurement values obtained by measuring a first electric characteristic and a second electric characteristic of the transistor and simulation values of first electric characteristic and the second electric characteristic which are expressed as functions of the plurality of parameters; and
a parameter extraction section for calculating a first relational expression of the plurality of parameters where the measurement value of the first electric characteristic agrees with the simulation value of the first electric characteristic and a second relational expression of the plurality of parameters where the measurement value of the second electric characteristic agrees with the simulation value of the second electric characteristic and for calculating modified values of the plurality of parameters with the use of the first relational expression and the second relational expression.
